(19) United States
(12) Patent Application Publication
(10) Pub. No.: US 2024/0167729 A1
(43) Pub. Date: May 23, 2024

(54) HELIOSTAT OPTICAL PANEL ASSEMBLY

(71) Applicant: Heliogen Holdings, Inc., Pasadena, CA (US)

(72) Inventors: Derek Evan Schulte, Pasadena, CA (US); Steven Edward Schell, Arcadia, CA (US)

(21) Appl. No.: 18/057,148

(22) Filed: Nov. 18, 2022

(51) Int. Cl. F24S 23/70

(52) U.S. Cl. CPC F24S 23/82; F24S 2023/832

(57) ABSTRACT

A heliostat optical panel assembly has a curved optical panel, a curved backing panel spaced from the curved optical panel and multiple spacers interposed between and attached to the curved optical panel and the curved backing panel. The spacers are distributed between the curved optical panel and the curved backing panel in a modular pattern to provide shear stiffness to the optical panel assembly.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The invention generally pertains to a heliostat device for capturing solar energy. In particular, the invention relates to a heliostat optical panel assembly with a plurality of spacers disposed between an optical panel (e.g., mirror) and a backing panel or sheet.

### Description of the Related Art

Conventional heliostats are prohibitively expensive to build and install. These conventional heliostats include mirrors which can experience extreme forces in windy conditions, but must maintain an accurate shape of their reflective surface nonetheless. To withstand the wind loading, conventional heliostats are generally constructed from structural steel and anchored into the ground with posts and concrete. Steel, however, is a relatively expensive building material, and the labor cost to drill and set posts is comparable to the price of the heliostat itself. Conventional heliostats are also complex and can be difficult and/or costly to maintain.

### SUMMARY

There is therefore a need for a cost-effective heliostat optical panel assembly that is simple in design and relatively simple to manufacture while providing high optical accuracy.

In accordance with one aspect of the disclosure an optical panel assembly for a heliostat is provided. The optical panel assembly comprises a curved optical panel and a curved backing panel spaced from the curved optical panel along its length to define a gap between the curved optical panel and the curved backing panel. The optical panel assembly also comprises a plurality of spacers interposed between and attached to the curved optical panel and the curved backing panel and distributed across an entirety of the gap between the curved optical panel and the curved backing panel.

In accordance with another aspect of the disclosure, an optical panel assembly for a heliostat is provided. The optical panel assembly comprises a spherically curved optical panel and a spherically curved backing panel spaced from the spherically curved optical panel along its length to define a gap between the spherically curved optical panel and the spherically curved backing panel. The optical panel assembly also comprises a plurality of spacers interposed between and adhered to the spherically curved optical panel and the spherically curved backing panel and distributed across an entirety of the gap between the spherically curved optical panel and the spherically curved backing panel.

In accordance with another aspect of the disclosure, a method of making an optical panel assembly is provided. The method includes the steps of: positioning an optical panel on a mandril, adhering one end of a plurality of spacers to a back side of the optical panel, and adhering a backing panel to an opposite end of the plurality of spacers to adhere the backing panel to the optical panel.

### BRIEF DESCRIPTION OF THE DRAWINGS

The present invention is illustrated by way of example and not limitation in the figures of the accompanying drawings, and in which:

FIG. 1 is a perspective view of a heliostat;

FIG. 2 is a bottom view of an optical panel assembly with a backing frame attached to a backing panel of the optical panel assembly;

FIG. 3 is a bottom view of the backing panel of the optical panel assembly of FIG. 2 with the backing frame removed;

FIG. 4 is a bottom view of the optical panel of a heliostat showing a layout of spacers thereon;

FIG. 5 is an exploded view of an optical panel assembly;

FIG. 6 is a side view of an assembled optical panel assembly;

FIG. 7 is an enlarged partial side view of an end of the optical panel assembly of FIG. 6;

FIG. 8A is a bottom perspective view of a spacer;

FIG. 8B is a top perspective view of the spacer in FIG. 8A;

FIG. 8C is a side view of the spacer in FIG. 8A;

FIG. 8D is a bottom view of the spacer in FIG. 8A;

FIG. 9A is a bottom perspective view of a spacer;

FIG. 9B is a side view of the spacer in FIG. 9A;

FIG. 10 is a side view of a spacer;

FIG. 11 is a bottom view of the backing panel of an optical panel assembly showing a layout of spacers thereon;

FIG. 12 is a bottom view of the backing panel of an optical panel assembly showing a layout of spacers thereon;

FIG. 13 is a bottom view of the backing panel of an optical panel assembly showing a layout of spacers thereon; and

FIG. 14 is a flowchart illustrating a process of manufacturing an optical panel assembly.

### DETAILED DESCRIPTION

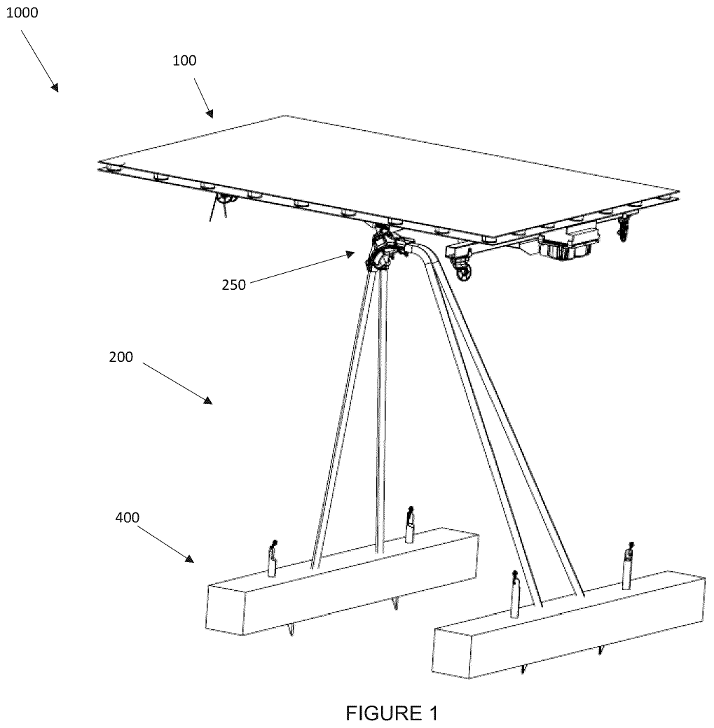

FIG. 1 shows a heliostat 1000 having an optical panel assembly 100 mounted on a stand 200 via a hinge assembly 250. The stand 200 can be attached to ballast masses 400 that in one implementation can be cement or concrete masses into which the legs of the stand 200 are embedded. The optical panel assembly 100 can in one implementation have a generally rectangular outer edge. However, the optical panel assembly 100 can have other suitable shapes (e.g., square, hexagonal, octagonal).

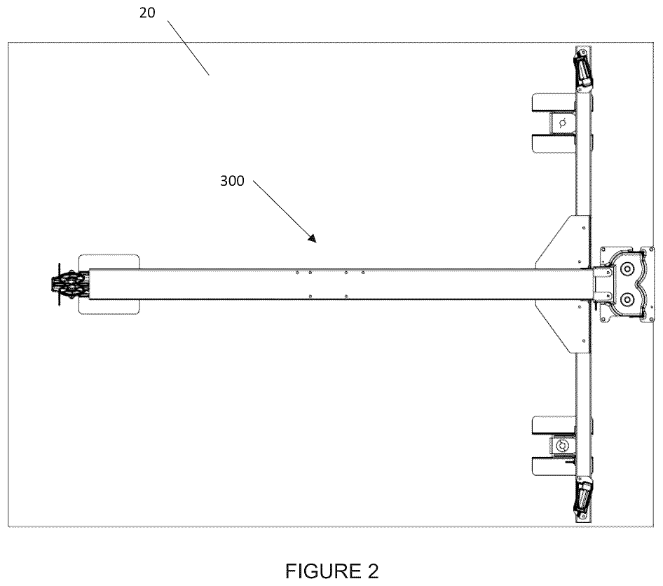

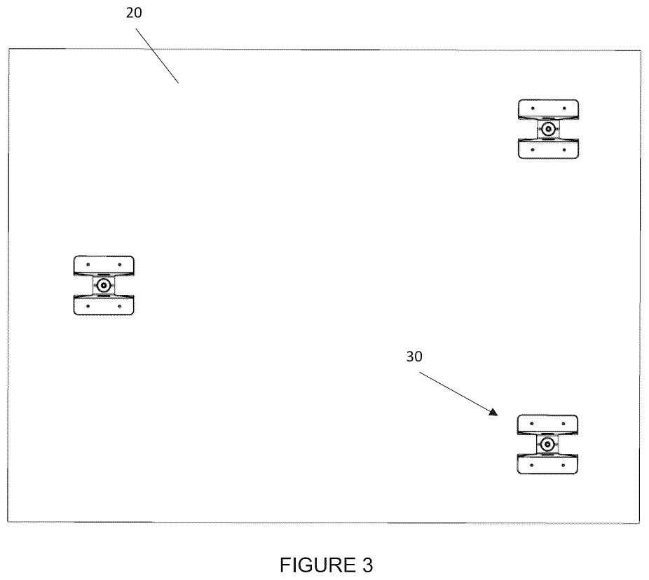

FIG. 2 shows a bottom view of a backing panel 20 of the optical panel assembly 100 with a frame 300 mounted thereon. FIG. 3 shows the bottom view of the backing panel 20 with the frame 300 removed, showing the brackets 30 on the backing panel 20 to which the frame 300 is coupled to mount the frame 300 to the backing panel 20. The hinge assembly 250 can couple to the frame 300.

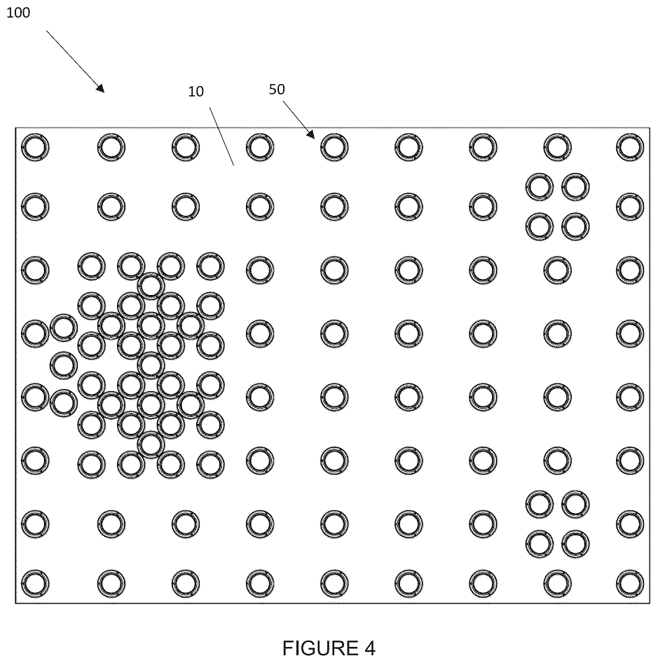

FIGS. 4-7 show various views of the optical panel assembly 100. FIG. 4 shows a bottom view of an optical panel 10 of the optical panel assembly 100 with a plurality of spacers 50 attached to the optical panel 10 and distributed across the surface of the optical panel 10 (e.g., along the panel edges, across the width and length of the panel, at locations that align with the location of the brackets 30 on the backing panel 20). In the illustrated implementation, a group of spacers 50 are concentrated proximate one end of the panel 10 adjacent a centerline of the optical panel 10. In one implementation, the spacers 50 are distributed in a uniform pattern, or at least some of the spacers 50 are distributed in a uniform pattern. In another implementation, the spacers 50 are distributed independently of each other (e.g., not in a uniform pattern).

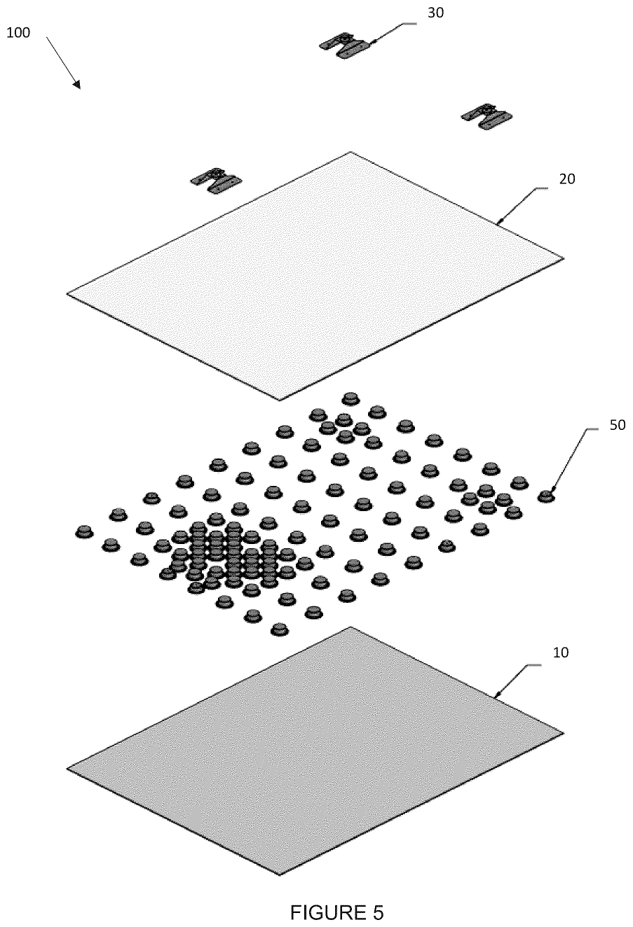

FIG. 5 shows an exploded view of the optical panel assembly 100, with the plurality of spacers 50 disposed between the optical panel 10 (e.g., mirror panel) and the backing panel 20. The spacers 50 are attached to a bottom surface of the optical panel 10 and a top surface of the backing panel 20. The brackets 30 are attached to the bottom surface of the backing panel 20.

The optical panel assembly 100 (e.g., the optical panel 10, the backing panel 20) can be curved. In one implementation the optical panel 10 can be spherically curved (e.g., have a curvature defined by a spherical surface). The optical panel 10 can in one implementation have outer dimensions of 1.2 meters by 1.6 meters and a thickness of approximately 3 mm. However, the optical panel 10 can have other suitable dimensions. In one implementation, the optical panel 10 can be a sheet of glass with reflective paint on a back side of the panel 10. The optical panel 10 can become curved when placed on (e.g., draped over) a mandril having a specific curvature, achieving the curvature of the mandril, as further discussed below. For example, where the mandril has a spherical curvature, the optical panel 10 attains a spherical curvature that approximates or is identical to that of the mandril when the optical panel 10 is placed over the mandril (e.g., to form a converging optic).

Additionally, in one implementation the backing panel 20 can be spherically curved (e.g., have a curvature defined by a spherical surface). The backing panel 20 can have the same length and width as the optical panel 10. The backing panel 20 can in one implementation have outer dimensions of 1.2 meters by 1.6 meters. However, the backing panel 20 can have other suitable dimensions. In one example, the backing panel 20 can have a thickness of approximately 3 mm. In one implementation, the backing panel 20 can be a sheet of metal. In another implementation, the backing panel 20 can be a sheet of glass. The backing panel 20 can become curved when placed on (e.g., draped over) the spacers attached to the optical panel 10 that has been draped over a mandril, as further discussed below. Accordingly, the backing panel 20 can attain a curvature (e.g., a spherical curvature) approximating or identical to the curvature of the mandril.

In one implementation, the optical panel 10 and the backing panel 20 can both be spherically curved and have the same curvature. In one implementation, the radius of curvature for the spherically curved optical panel 10 can be 20-500 m (e.g., the optical panel 10 is a converging optic).

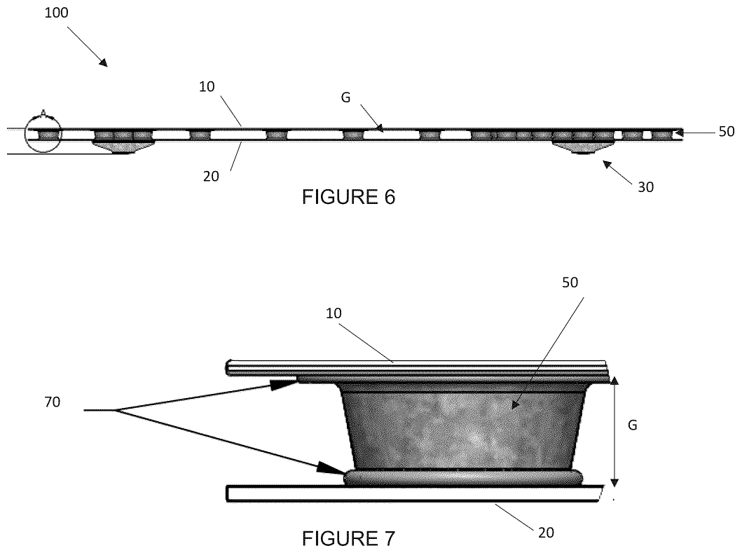

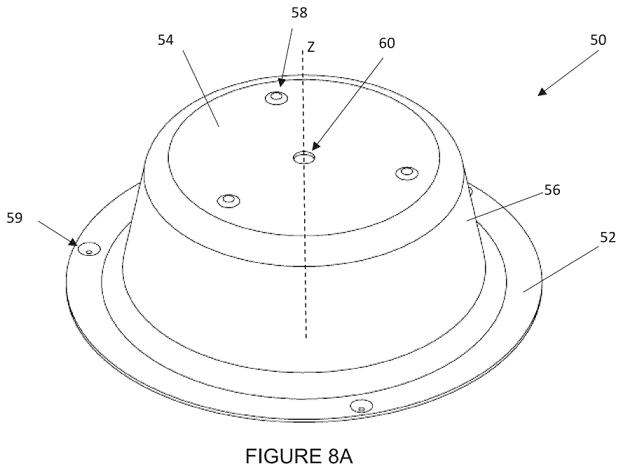

FIGS. 6-7 show a side view of the assembled optical panel assembly 100. The spacers 50 are attached to the bottom surface of the optical panel 10 and the top surface of the backing panel 20 with an adhesive 70. In one implementation, the adhesive 70 is applied at separate discrete locations where the spacers 50 are to be coupled to the optical panel 10. The adhesive 70 can have a thickness that provides desired performance and strength and reduces (e.g., minimizes, avoids) waste of adhesive. In one implementation, the adhesive 70 has a thickness of between about 0.254 mm and about 0.762 mm (e.g., 0.254 mm, 0.762 mm). The spacers 50 are interposed between the optical panel 10 and the backing panel 20 so that the optical panel 10 is spaced from the backing panel 20 by a gap G.

As shown in FIG. 6, the spacers 50 are distributed across the gap G along the length and width of the optical panel assembly 100 (e.g., laterally spaced along the length and width of the optical panel 10, along the length and width of the backing panel 20, along an entirety of the gap G). Advantageously, the spacers 50 provide uniform and high shear stiffness (e.g., in the horizontal direction in FIG. 6). For example, the spacers 50 provide resistance to shear forces between the optical panel 10 and the backing panel 20. Additionally, the spacers 50 provide a low cost, reduced weight, and modular way of mounting the optical panel 10 to the backing panel 20, for example as compared with having a continuous uniform filler sheet between the optical panel 10 and the backing panel 20. Further, the use of the spacers 50 advantageously inhibits (e.g., prevents) a mismatch in the coefficient of thermal expansion (CTE) between the different components of the optical panel assembly 100 (e.g., CTE of the optical panel 10, CTE of the spacers 50, CTE of the backing panel 20) from affecting the shape of the optical panel assembly 100. Since a plurality of discrete spaced apart spacers 50 are used to interconnect the optical panel 10 with the backing panel 20 (using the adhesive 70), any CTE mismatch is limited to the location of each of the spacers 50 and its magnitude can be accommodated by the adhesive to inhibit a deformation or change in the shape of the optical panel 10. Additionally, the modular design of the optical panel assembly 100, which allows for the modification of the arrangement of spacers during the manufacture process, advantageously allows of the optical panel assembly 100 to be designed for the expected wind loads at the particular location where the optical panel assembly 100 is to be installed (e.g., the spacers 50 are arranged to provide optimal stiffness across the area of the optical panel assembly 100), as further discussed below.

With reference to FIGS. 5-7, in one implementation, the spacers 50 are attached to the optical panel 10 and the backing panel 20 so that the upper wall 52 of the spacer 50 is proximate the optical panel 10 and the lower wall 54 of the spacer 50 is proximate the backing panel 20. The adhesive 70 is disposed between at least a portion of the upper wall 52 and the optical panel 10 and disposed between at least a portion of the lower wall 54 and the backing panel 20. The dimples 58 provide the bond line thickness for the adhesive (e.g., set the adhesive thickness, such as the adhesive thickness limit) between the spacer 50 and the optical panel 10 and the backing panel 20.

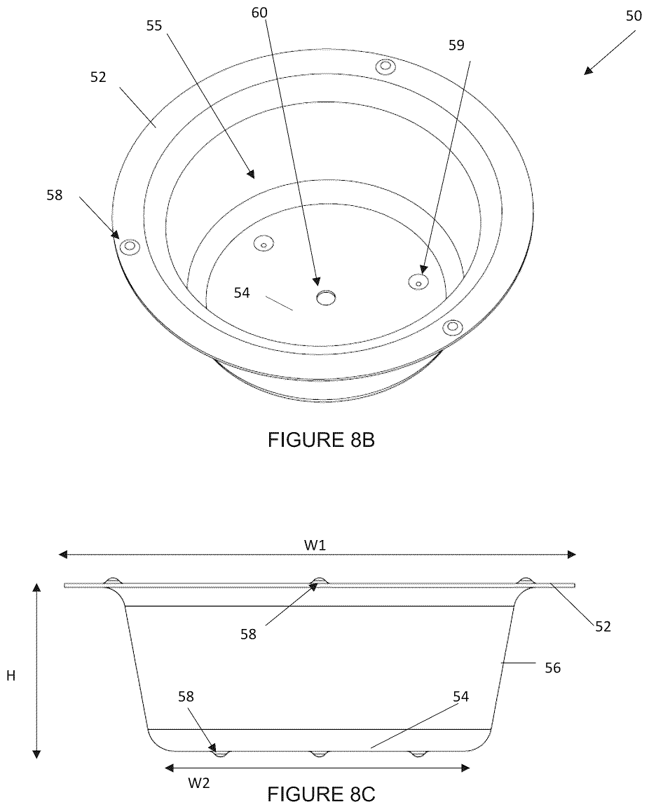

FIGS. 8A-8D show a spacer 50 for use in a optical panel assembly 100, as described above. The spacer 50 has an upper wall 52, a lower wall 54 and a sidewall 56 (e.g., peripheral sidewall, circumferential sidewall) that extends between and interconnects the upper wall 52 and the lower wall 54. As shown in FIGS. 8A-8D, the spacer 50 has a conical shape that is symmetrical about a central axis Z of the spacer 50. In the illustrated implementation, the upper wall 52 is an annular wall (e.g., annular flange) with an outer width or diameter W1, the lower wall 54 is circular and has an outer width or diameter W2 that is smaller than the outer width or diameter W1 of the upper wall 52, and the spacer 50 has a height H. In one implementation, the outer width or diameter W1 of the upper wall 52 can be between 60 mm and 120 mm (e.g., can be 60 mm, can be 120 mm). In one implementation, the spacer 50 can have an aspect ratio (e.g., of the outer width or diameter W1 of the upper wall 52 to the height H) of about 2 to 1. With reference to FIG. 8B, the sidewall 56 and the lower wall 54 define an open cavity 55. In one implementation, the lower wall 54 optionally has a vent hole 60 in communication with the cavity 55, the vent hole 60 being optionally located at the center of the lower wall 54 and aligned with the central axis Z. Advantageously, the vent hole 60 allows for air to exit the cavity 55 when attaching (e.g., adhering) the spacer 50 to the optical panel 10 during manufacture, as further discussed below, thereby inhibiting (e.g., preventing) air pressure in the cavity 55 from displacing the spacer 50 relative to the optical panel 10.

With reference to FIGS. 8A and 8B, the spacer 50 has one or more (e.g., three, at least three) dimples 58 or protrusions that extend from (e.g., protrude from) the lower wall 54 and one or more (e.g., three, at least three) dimples 58 or protrusions that extend from the upper wall 52. In one implementation, the dimples 58 can have a curved surface. The dimples 58 can be radially spaced apart equidistantly from each other about the central axis Z. The dimples 58 are formed in the lower wall 54 and the upper wall 52 so that a corresponding recess 59 is formed on the opposite side of the lower wall 54 and the upper wall 52 for each of the dimples 58. As shown in the implementation in FIG. 8D, the dimples 58 on the lower wall 54 are offset (e.g., angularly offset along a circumference of the spacer 50) relative to the dimples 58 of the upper wall 52 so that each of the dimples 58 on the lower wall 54 is angularly arranged between two of the dimples on the upper wall 52.

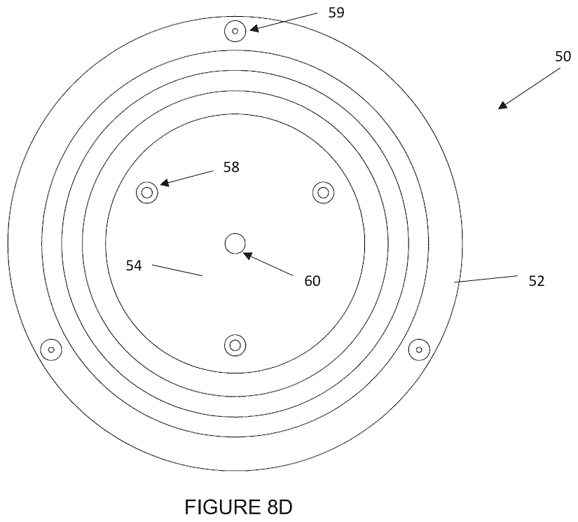

FIGS. 9A-9B show a spacer 50′. The spacer 50′ is channel shaped with an upper wall 52′ (e.g., pair of spaced apart upper walls 52′), a lower wall 54′ and sidewalls 56′ that extend between and interconnect the lower wall 54′ and the upper wall 52′ (e.g., the pair of spaced apart upper walls 52′). In the illustrated implementation, the sidewalls 56′ extend perpendicular to the lower wall 54′ and the upper wall 52′. In another implementation, the sidewalls 56′ can extend at an angle (e.g., other than 90 degrees) relative to the lower wall 54′ and the upper wall 52′. The lower wall 54′ and the sidewalls 56′ define an open cavity 55′. As shown in FIG. 9A, the lower wall 54′ and upper wall 52′ (e.g., pair of spaced apart upper walls 52′) can be planar and rectangular. In one implementation, a plurality of spacers 50′ can be disposed between and attached (e.g., with an adhesive) to the optical panel 10 and the backing panel 20 to form an optical panel assembly (e.g., similar to the optical panel assembly 100 with the spacers 50′ replacing the spacers 50). For example, the upper wall 52′ (e.g., pair of spaced apart upper walls 52′) can be attached to (e.g., adhered with the adhesive 70) to a backside of the optical panel 10 and the lower wall 54′ can be attached to (e.g., adhered with the adhesive 70) to the top side of the backing panel 20. Though not shown in FIG. 9A, in one implementation, the spacer 50′ can have dimples (e.g., similar to dimples 58) on the upper wall 52′ (e.g., on the pair of spaced apart upper walls 52′) and/or on the lower wall 54′. As show in FIG. 9A, the ends of the cavity 55′ are open to allow air to pass therethrough, so the spacer 50′ can exclude a vent hole on the lower wall 54′ (e.g., similar to the vent hole 60).

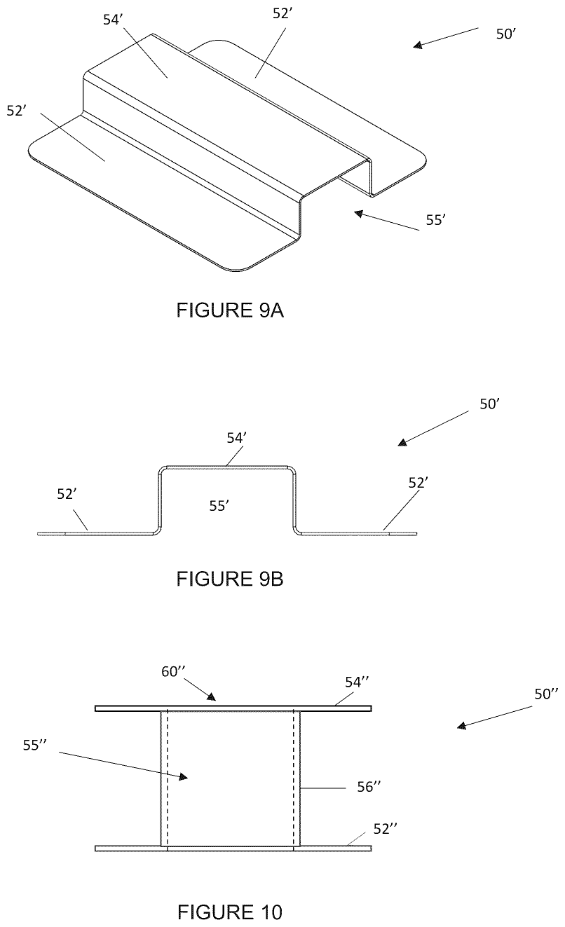

FIG. 10 shows a sideview spacer 50″. The spacer 50″ has an upper wall 52″, a lower wall 54″ and a sidewall 56″ (e.g., a peripheral or circumferential sidewall) that extends between and interconnects the lower wall 54″ and the upper wall 52″. In the illustrated implementation, the upper wall 52″ and the lower wall 54″ have the same outer dimension (e.g., outer diameter, outer width) and/or same contact area (e.g., area that contacts the optical panel 10 and the backing panel 20). In the illustrated implementation, the sidewall 56″ extend perpendicular to the lower wall 54″ and the upper wall 52″. In another implementation, the sidewall 56″ can extend at an angle (e.g., other than 90 degrees) relative to the lower wall 54″ and the upper wall 52″. In one example, the spacer 50″ is spool shaped where the upper wall 52″ has a circular outer perimeter, the lower wall 54″ has a circular outer perimeter and the sidewall 56″ is cylindrical. In another example, the spacer 50″ can be shaped like an I-beam, where the upper wall 52″ is a pair of spaced apart (rectangular) upper walls or flanges 52″, the lower wall 54″ is a pair of spaced apart (rectangular) lower walls or flanges 56″ and the sidewall 56″ is a pair of rectangular walls that extend between the upper wall 52″ and the lower wall 54″.

The sidewall 56″ can be hollow and define an open cavity 55″ with open ends at the upper wall 52″ and the lower wall 54″. The opening or vent 60″ on the lower wall 54″ can allow air to pass therethrough and prevent air pressure from building in the cavity and displacing the spacer 50″ when the spacer 50″ is attached to (e.g., adhered with the adhesive) to the optical panel 10 (e.g., to form an optical panel assembly). As shown in FIG. 10, the lower wall 54″ and upper wall 52″ can be planar. In one implementation, a plurality of spacers 50″ can be disposed between and attached (e.g., with an adhesive) to the optical panel 10 and the backing panel 20 to form an optical panel assembly (e.g., similar to the optical panel assembly 100 with the spacers 50″ replacing the spacers 50). For example, the upper wall 52″ can be attached to (e.g., adhered with the adhesive 70) to a backside of the optical panel 10 and the lower wall 54′ can be attached to (e.g., adhered with the adhesive 70) to the top side of the backing panel 20. Tough not shown in FIG. 10, in one implementation, the spacer 50″ can have dimples (e.g., similar to dimples 58) on the upper wall 52″ and/or on the lower wall 54″.

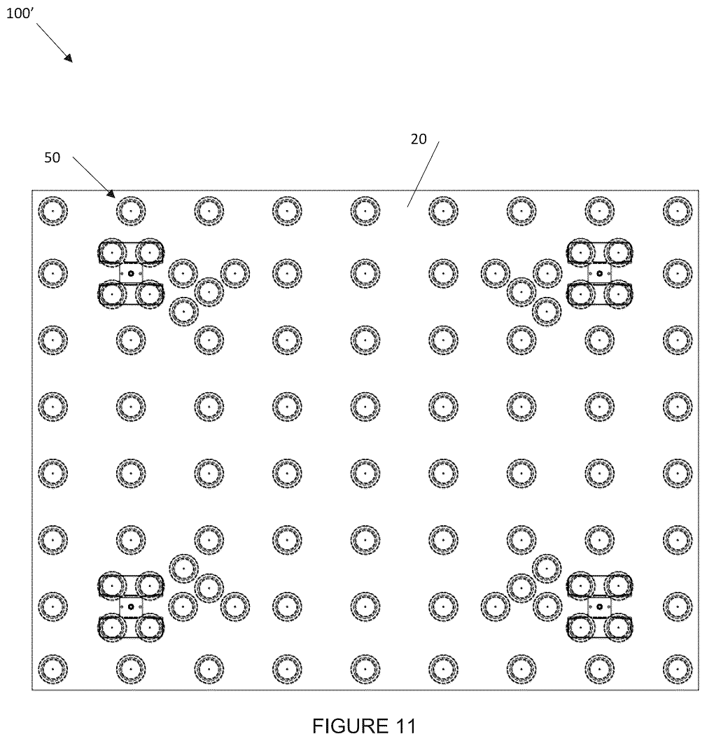

FIG. 11 shows a portion of an optical panel assembly 100′ with spacers 50 attached to the backing panel 20. The optical panel assembly 100′ is similar to the optical panel assembly 100 shown in FIGS. 1-7. Thus, reference numerals used to designate the various components of the optical panel assembly 100′ are identical to those used for identifying the corresponding components of the optical panel assembly 100 in FIGS. 1-7. Therefore, the structure and description for the various features of the optical panel assembly 100 in FIGS. 1-7 are understood to also apply to the corresponding features of the optical panel assembly 100′ in FIG. 11, except as described below.

The optical panel assembly 100′ differs from the optical panel assembly 100 in how and where the spacers 50 are distributed between the optical panel (not shown) and the backing panel 20. In the illustrated implementation, spacers 50 are uniformly distributed (e.g., in perpendicular rows and columns) along the length and width of the optical panel assembly 100′ with additional three spacers 50 proximal to locations near each of the brackets (e.g., brackets 30) attached to the backing panel 20, and four spacers 50 located at the location of each of the brackets (e.g., brackets 30).

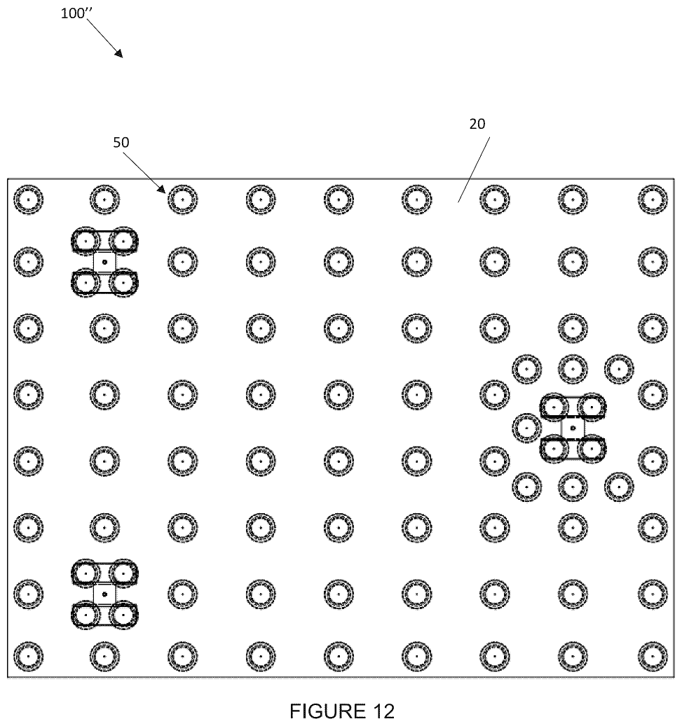

FIG. 12 shows a portion of an optical panel assembly 100″ with spacers 50 attached to the backing panel 20. The optical panel assembly 100″ is similar to the optical panel assembly 100 shown in FIGS. 1-7. Thus, reference numerals used to designate the various components of the optical panel assembly 100″ are identical to those used for identifying the corresponding components of the optical panel assembly 100 in FIGS. 1-7. Therefore, the structure and description for the various features of the optical panel assembly 100 in FIGS. 1-7 are understood to also apply to the corresponding features of the optical panel assembly 100″ in FIG. 12, except as described below.

The optical panel assembly 100″ differs from the optical panel assembly 100 in how and where the spacers 50 are distributed between the optical panel (not shown) and the backing panel 20. In the illustrated implementation, spacers 50 are uniformly distributed (e.g., in perpendicular rows and columns) along the length and width of the optical panel assembly 100″ with additional three spacers 50 disposed between two rows of spacers 50 near one side of one of the brackets (e.g., bracket 30), and two spacers 50 disposed between two rows of spacers 50 near an opposite side of said one of the brackets (e.g., bracket 30), and four spacers 50 located at the location of each of the brackets (e.g., brackets 30).

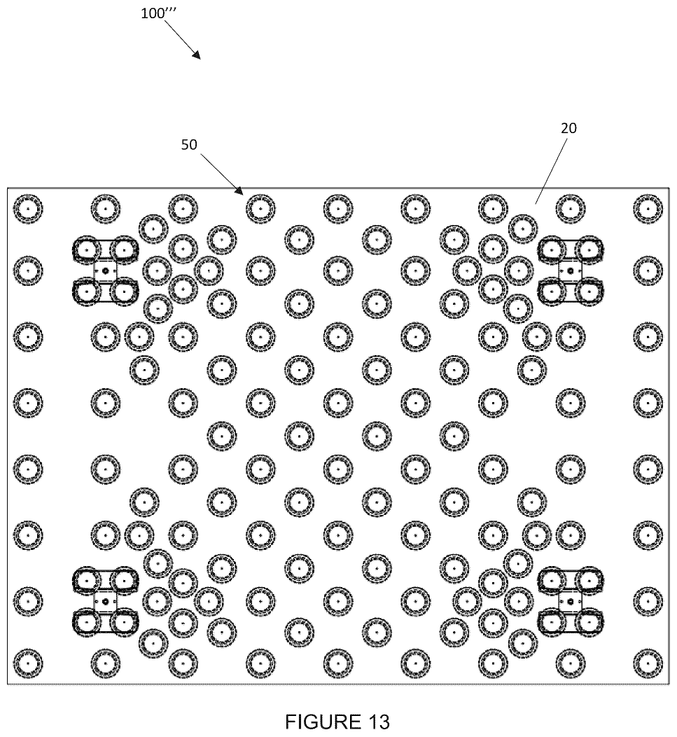

FIG. 13 shows a portion of an optical panel assembly 100′″ with spacers 50 attached to the backing panel 20. The optical panel assembly 100′″ is similar to the optical panel assembly 100 shown in FIGS. 1-7. Thus, reference numerals used to designate the various components of the optical panel assembly 100′″ are identical to those used for identifying the corresponding components of the optical panel assembly 100 in FIGS. 1-7. Therefore, the structure and description for the various features of the optical panel assembly 100 in FIGS. 1-7 are understood to also apply to the corresponding features of the optical panel assembly 100′″ in FIG. 13, except as described below.

The optical panel assembly 100′″ differs from the optical panel assembly 100 in how and where the spacers 50 are distributed between the optical panel (not shown) and the backing panel 20. In the illustrated implementation, the spacers 50 are distributed in perpendicular rows and columns along the length and width of the optical panel assembly 100′″, with some of the rows or columns being offset relative to other rows and columns or having different number of spacers 50. As shown in FIG. 13, a larger number of spacers 50 are located in the central region of the optical panel assembly and near a location of each of the brackets (e.g., bracket 30) attached to the backing panel 20, and four spacers 50 located at the location of each of the brackets (e.g., brackets 30).

Advantageously, the spacers 50, 50′, 50″ allow a modular construction of optical panel assemblies, such as optical panel assembly 100, 100′, 100″, where the distribution of spacers 50, 50′, 50″ in the optical panel assembly form a modular core that can be tailored to the environment where the optical panel assembly will be used. For example, an optical panel assembly that will be used in a location that typically experiences winds of 70 miles per hour will have a different distribution of spacers 50, 50′, 50″ than an optical panel assembly that will be used in a location that typically experiences winds of 100 miles per hour. Accordingly, the use of the spacers, such as spacers 50, 50′, 50″, as discussed above, allows the optical panel assembly to be used and tailored for use in various different environment and have a stiffness to meet the different loading requirement for said environment.

In one implementation, the spacers 50, 50′, 50″ can be made of metal. For example, the spacers 50, 50′, 50″ can be made of aluminum, stainless steel, or carbon steel, such as low-carbon steel or commercial steel. In one implementation the spacers 50, 50′, 50″ can include a corrosion-resistant coating (e.g., a zinc-aluminum coating).

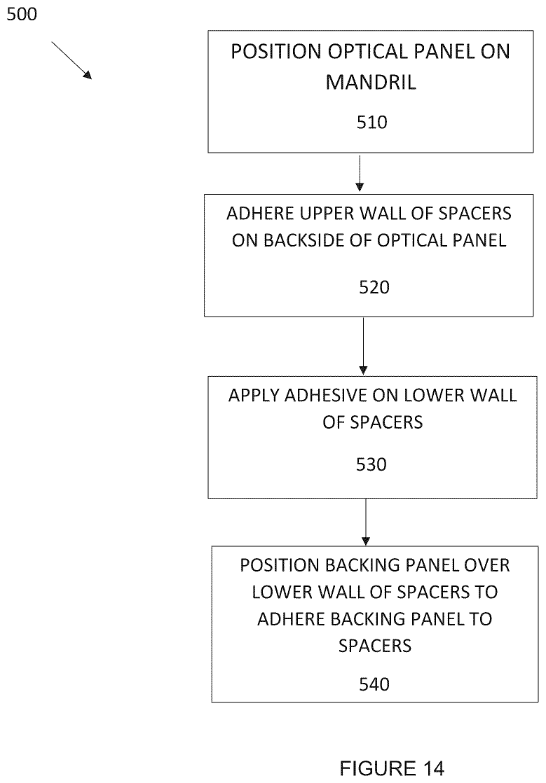

FIG. 14 shows a process 500 for manufacturing or assembling an optical panel assembly, such as the optical panel assembly 100 in FIGS. 1-7. The process or method 500 includes the step of positioning 510 (e.g., draping) the optical panel (such as optical panel 10) on a mandril. The mandril can have a curved surface (e.g., a spherically curved surface), and positioning (e.g., draping) the optical panel on the mandril allows the optical panel to attain a curved shape approximate to or identical to the curved surface (e.g., a spherically curved surface) of the mandril.

The method 500 also includes the step of adhering 520 the spacers (e.g., the upper wall of the spacers, such as upper wall 52, 52′, 52″ of spacers 50, 50′, 50″) to the backside of the optical panel (e.g., optical panel 10) while it is on the mandril. In one example, the adhesive is first applied to the back side of the optical panel and the spacers (e.g., spacers 50, 50′, 50″) are then placed on the adhesive (e.g., adhesive 70). In another example, the adhesive is first applied to the spacers and each spacer is then attached to the backside of the optical panel in the arrangement (e.g., distribution) particular for the optical panel assembly to be used in a particular environment (e.g., based on expected wind loads in such an environment). With respect to the spacers 50, as both the upper wall 52 and lower wall 54 are circular, the upper wall 52 of the spacers 50 would contact the spherical surface of the optical panel 10. Where the spacer 50 has dimples 58, as shown above in FIGS. 8A-8D, the dimples 58 on the upper wall 52 would contact the spherical surface of the optical panel (e.g., optical panel 10) positioned over the mandril, advantageously controlling the adhesive thickness to be equal to the height of the dimples. Where the spacer 50 has the vent hole 60, the vent hole 60 advantageously allows air to exit the cavity 55 via the vent hole 60 to inhibit (e.g., prevent) air pressure in the cavity 55 when attaching the spacer 50 to the optical panel from displacing the spacer.

The process or method 500 also includes the step of applying 530 an adhesive on the lower wall of the spacer(s) (e.g., the spacers 50, 50′, 50″). The process or method also includes the step of positioning 540 the backing panel (e.g., backing panel 20) over the lower wall (e.g., lower wall 54, 54′, 54″) of the spacers (e.g., spacers 50, 50′, 50″) to adhere the backing panel to the spacers. With respect to the spacers 50, as both the upper wall 52 and lower wall 54 are circular, the lower wall 54 of the spacers 50 would contact the surface of the backing panel 20. Where the spacer 50 has dimples 58, as shown above in FIGS. 8A-8D, the dimples 58 on the lower wall 54 would contact the surface of the backing panel (e.g., backing panel 20), advantageously controlling the adhesive thickness to be equal to the height of the dimples. The backing panel would attain a curved shape based on the distribution of the spacers that are positioned over the curved optical member and present a generally curved projected surface on which the backing panel is positioned. In one implementation, the backing panel (e.g., backing panel 20) can attain a curved surface that approximates or is identical to the curved surface of the optical panel.

### Additional Embodiments

In embodiments of the present disclosure, an optical panel assembly may be in accordance with any of the following clauses:
Clause 1. An optical panel assembly for a heliostat, comprising:
   a curved optical panel;
   a curved backing panel spaced from the curved optical panel along its length to define a gap between the curved optical panel and the curved backing panel; and
   a plurality of spacers interposed between and attached to the curved optical panel and the curved backing panel and distributed across an entirety of the gap between the curved optical panel and the curved backing panel.
Clause 2. The optical panel assembly of Clause 1, wherein a first group of two or more of the plurality of spacers are laterally spaced from each other by a first distance and a second set of two or more of the plurality of spacers are laterally spaced from each other by a second distance different than the first distance.
Clause 3. The optical panel assembly of any preceding clause, further comprising an adhesive, the plurality of spacers being adhered to the curved optical panel and the curved backing panel with the adhesive.
Clause 4. The optical panel assembly of any preceding clause, wherein the curved optical panel and the curved backing panel are each spherically curved.
Clause 5. The optical panel assembly of any preceding clause, wherein each of the plurality of spacers has a shape symmetrical about a central axis of the spacer, the spacer having an upper wall, a lower wall and a sidewall that extends between and interconnects the lower wall and the upper wall.
Clause 6. The optical panel assembly of Clause 5, wherein the sidewall is conical, the upper wall is an annular wall, and the lower wall is a circular wall.
Clause 7. The optical panel assembly of Clause 5, wherein the lower wall includes a vent hole.
Clause 8. The optical panel assembly of Clause 7, further comprising multiple dimples that protrude from each of the upper wall and the lower wall, the dimples radially spaced apart equidistantly about the central axis.
Clause 9. The optical panel assembly of Clause 8, wherein said multiple dimples are three dimples.
Clause 10. The optical panel assembly of any preceding clause, wherein each of the plurality of spacers has a channel shape with a rectangular upper wall, a pair of side walls that extend perpendicular to the rectangular upper wall, and a pair of lower walls that extend outward from and perpendicular to the pair of side walls.
Clause 11. An optical panel assembly, comprising:
   a spherically curved optical panel;
   a spherically curved backing panel spaced from the spherically curved optical panel along its length to define a gap between the spherically curved optical panel and the spherically curved backing panel; and
   a plurality of spacers interposed between and adhered to the spherically curved optical panel and the spherically curved backing panel and distributed across an entirety of the gap between the spherically curved optical panel and the spherically curved backing panel.
Clause 12. The optical panel assembly of Clause 11, wherein a first group of two or more of the plurality of spacers are laterally spaced from each other by a first distance and a second set of two or more of the plurality of spacers are laterally spaced from each other by a second distance different than the first distance.
Clause 13. The optical panel assembly of any of Clauses 11-12, wherein each of the plurality of spacers are symmetrical about a central axis of the spacer, the spacer having an upper wall, a lower wall and a sidewall that extends between and interconnects the lower wall and the upper wall.
Clause 14. The optical panel assembly of Clause 13, wherein the sidewall is conical, the upper wall is an annular wall, and the lower wall is a circular wall.
Clause 15. The optical panel assembly of Clause 14, wherein the lower wall includes a vent hole.
Clause 16. The optical panel assembly of Clause 15, further comprising multiple dimples that protrude from each of the upper wall and the lower wall, the dimples radially spaced apart equidistantly about the central axis.
Clause 17. The optical panel assembly of any of Clauses 11-16, wherein each of the plurality of spacers has a channel shape with a rectangular upper wall, a pair of side walls that extend perpendicular to the rectangular upper wall, and a pair of lower walls that extend outward from and perpendicular to the pair of side walls.

While certain embodiments of the inventions have been described, these embodiments have been presented by way of example only and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed devices.

What is claimed is:

1. An optical panel assembly for a heliostat, comprising:
a curved optical panel;
a curved backing panel spaced from the curved optical panel along its length to define a gap between the curved optical panel and the curved backing panel; and
a plurality of spacers interposed between and attached to the curved optical panel and the curved backing panel and distributed across an entirety of the gap between the curved optical panel and the curved backing panel.

2. The optical panel assembly of claim 1, wherein a first group of two or more of the plurality of spacers are laterally spaced from each other by a first distance and a second set of two or more of the plurality of spacers are laterally spaced from each other by a second distance different than the first distance.

3. The optical panel assembly of claim 1, further comprising an adhesive, the plurality of spacers being adhered to the curved optical panel and the curved backing panel with the adhesive.

4. The optical panel assembly of claim 1, wherein the curved optical panel and the curved backing panel are each spherically curved.

5. The optical panel assembly of claim 1, wherein each of the plurality of spacers has a shape symmetrical about a central axis of the spacer, the spacer having an upper wall, a lower wall and a sidewall that extends between and interconnects the lower wall and the upper wall.

6. The optical panel assembly of claim 5, wherein the sidewall is conical, the upper wall is an annular wall, and the lower wall is a circular wall.

7. The optical panel assembly of claim 5, wherein the lower wall includes a vent hole.

8. The optical panel assembly of claim 7, further comprising multiple dimples that protrude from each of the upper wall and the lower wall, the dimples radially spaced apart equidistantly about the central axis.

9. The optical panel assembly of claim 8, wherein said multiple dimples are three dimples.

10. The optical panel assembly of claim 1, wherein each of the plurality of spacers has a channel shape with a rectangular upper wall, a pair of side walls that extend perpendicular to the rectangular upper wall, and a pair of lower walls that extend outward from and perpendicular to the pair of side walls.

11. An optical panel assembly, comprising:
a spherically curved optical panel;
a spherically curved backing panel spaced from the spherically curved optical panel along its length to define a gap between the spherically curved optical panel and the spherically curved backing panel; and
a plurality of spacers interposed between and adhered to the spherically curved optical panel and the spherically curved backing panel and distributed across an entirety of the gap between the spherically curved optical panel and the spherically curved backing panel.

12. The optical panel assembly of claim 11, wherein a first group of two or more of the plurality of spacers are laterally spaced from each other by a first distance and a second set of two or more of the plurality of spacers are laterally spaced from each other by a second distance different than the first distance.

13. The optical panel assembly of claim 11, wherein each of the plurality of spacers are symmetrical about a central axis of the spacer, the spacer having an upper wall, a lower wall and a sidewall that extends between and interconnects the lower wall and the upper wall.

14. The optical panel assembly of claim 13, wherein the sidewall is conical, the upper wall is an annular wall, and the lower wall is a circular wall.

15. The optical panel assembly of claim 14, wherein the lower wall includes a vent hole.

16. The optical panel assembly of claim 15, further comprising multiple dimples that protrude from each of the upper wall and the lower wall, the dimples radially spaced apart equidistantly about the central axis.

17. The optical panel assembly of claim 11, wherein each of the plurality of spacers has a channel shape with a rectangular upper wall, a pair of side walls that extend perpendicular to the rectangular upper wall, and a pair of lower walls that extend outward from and perpendicular to the pair of side walls.

18. A method for manufacturing an optical panel assembly, comprising:
positioning an optical panel on a mandril;
adhering one end of a plurality of spacers to a back side of the optical panel; and
adhering a backing panel to an opposite end of the plurality of spacers to adhere the backing panel to the optical panel.

19. The method of claim 18, wherein the plurality of spacers are distributed between the optical panel and the backing panel so that a spacing between the spacers is not uniform.
